(19) United States
(12) Patent Application Publication
(10) Pub. No.: US 2026/0045260 A1
(43) Pub. Date: Feb. 12, 2026

(54) ENVIRONMENT BASED USER MODEL CREATION AND USER VERIFICATION

(71) Applicant: QUALCOMM Incorporated, San Diego, CA (US)

(72) Inventors: Hesu HUANG, San Diego, CA (US); Kwihyuk JIN, San Diego, CA (US); Vikranth SIDDENKI, Poway, CA (US); Dinesh RAMAKRISHNAN, Irvine, CA (US)

(21) Appl. No.: 18/797,292

(22) Filed: Aug. 7, 2024

(51) Int. Cl. G10L 17/04; G10L 15/22

(52) U.S. Cl. CPC G10L 17/04; G10L 15/22

(57) ABSTRACT

A device includes a memory configured to store multiple user models indicative of speech characteristics of a user. The device also includes one or more processors coupled to the memory and configured to obtain an audio input signal and perform a context detection operation to obtain environment information associated with the audio input signal. The processor(s) are configured to select a user model from among the multiple user models based on the environment information. The processor(s) are configured to obtain, based on the audio input signal and the selected user model, a user verification output indicative of whether the audio input signal corresponds to speech of the user. The processor(s) are configured to, based on obtaining a threshold number of samples of the user's speech in a particular environment, automatically generate a user model, of the multiple user models, indicative of the user's speech characteristics for the particular environment.

### I. FIELD

The present disclosure is generally related to performing user verification at an electronic device.

### II. Description of Related Art

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

User verification is a technique that is commonly used in portable personal computing devices. User verification includes analyzing captured speech, such as from a microphone of a device, to determine whether the speech matches that of a known user of the device. User verification is widely used for different use cases like voice activation, user authentication, etc. Such use cases require user verification performance to be robust and accurate for different environments, e.g., in a car, outdoors, at home, in a restaurant, etc. However, in some environments, the background environmental noise can be loud, which degrades user verification accuracy. In addition, an initial user enrollment is typically performed in a quiet environment to capture speech characteristics of the user. When performing user verification in different noisy environments, a mismatch between the enrollment environment and the verification environment can result in reduced user verification performance.

### III. SUMMARY

According to one implementation of the present disclosure, a device includes a memory configured to store multiple user models indicative of speech characteristics of a user. The device also includes one or more processors coupled to the memory. The one or more processors are configured to obtain an audio input signal and perform a context detection operation to obtain environment information associated with the audio input signal. The one or more processors are configured to select a user model from among the multiple user models based on the environment information. The one or more processors are configured to obtain, based on the audio input signal and the selected user model, a user verification output indicative of whether the audio input signal corresponds to speech of the user. The one or more processors are also configured to, based on obtaining a threshold number of samples of the user's speech in a particular environment, automatically generate a user model, of the multiple user models, indicative of the user's speech characteristics for the particular environment.

According to another implementation of the present disclosure, a method includes obtaining an audio input signal at a device and performing, at the device, a context detection operation to obtain environment information associated with the audio input signal. The method includes selecting, at the device and based on the environment information, a user model from among multiple user models indicative of speech characteristics of a user. The method includes obtaining, at the device and based on the audio input signal and the selected user model, a user verification output indicative of whether the audio input signal corresponds to speech of the user. The method also includes, based on obtaining a threshold number of samples of the user's speech in a particular environment, automatically generating a user model, of the multiple user models, indicative of the user's speech characteristics for the particular environment.

According to another implementation of the present disclosure, a non-transitory computer-readable medium stores instructions that are executable by one or more processors to cause the one or more processors to obtain an audio input signal and perform a context detection operation to obtain environment information associated with the audio input signal. The instructions are executable to cause the one or more processors to select, based on the environment information, a user model from among multiple user models indicative of speech characteristics of a user. The instructions are executable to cause the one or more processors to obtain, based on the audio input signal and the selected user model, a user verification output indicative of whether the audio input signal corresponds to speech of the user. The instructions are also executable to cause the one or more processors to, based on obtaining a threshold number of samples of the user's speech in a particular environment, automatically generate a user model, of the multiple user models, indicative of the user's speech characteristics for the particular environment.

According to another implementation of the present disclosure, an apparatus includes means for obtaining an audio input signal. The apparatus includes means for performing a context detection operation to obtain environment information associated with the audio input signal. The apparatus includes means for selecting, based on the environment information, a user model from among multiple user models indicative of speech characteristics of a user. The apparatus includes means for obtaining, based on the audio input signal and the selected user model, a user verification output indicative of whether the audio input signal corresponds to speech of the user. The apparatus also includes means for, based on obtaining a threshold number of samples of the user's speech in a particular environment, automatically generating a user model, of the multiple user models, indicative of the user's speech characteristics for the particular environment.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system including a device configured to perform environment based user model creation and user verification, in accordance with some examples of the present disclosure.

FIG. 2 is a diagram of an illustrative aspect of operations associated with the system of FIG. 1, in accordance with some examples of the present disclosure.

FIG. 3 is a diagram of an illustrative aspect of operations associated with the system of FIG. 1, in accordance with some examples of the present disclosure.

FIG. 4 is a diagram of an illustrative aspect of operations associated with the system of FIG. 1, in accordance with some examples of the present disclosure.

FIG. 5 is a diagram of an illustrative aspect of operations associated with the system of FIG. 1, in accordance with some examples of the present disclosure.

FIGS. 6A, 6B, and 6C are diagrams of illustrative aspects of operations associated with the system of FIG. 1, in accordance with some examples of the present disclosure.

FIG. 7 is a diagram of an example of an integrated circuit operable to perform environment based user model creation and user verification, in accordance with some examples of the present disclosure.

FIG. 8 is a diagram of a mobile device operable to perform environment based user model creation and user verification, in accordance with some examples of the present disclosure.

FIG. 9 is a diagram of a headset operable perform environment based user model creation and user verification, in accordance with some examples of the present disclosure.

FIG. 10 is a diagram of a wearable electronic device operable to perform environment based user model creation and user verification, in accordance with some examples of the present disclosure.

FIG. 11 is a diagram of a voice-controlled speaker system operable to perform environment based user model creation and user verification, in accordance with some examples of the present disclosure.

FIG. 12 is a diagram of a camera operable to perform environment based user model creation and user verification, in accordance with some examples of the present disclosure.

FIG. 13 is a diagram of a headset, such as a virtual reality, mixed reality, or augmented reality headset, operable to perform environment based user model creation and user verification, in accordance with some examples of the present disclosure.

FIG. 14 is a diagram of a first example of a vehicle operable to perform environment based user model creation and user verification, in accordance with some examples of the present disclosure.

FIG. 15 is a diagram of a second example of a vehicle operable to perform environment based user model creation and user verification, in accordance with some examples of the present disclosure.

FIG. 16 is a diagram of a particular implementation of a method of environment based user model creation and user verification that may be performed by the system of FIG. 1, in accordance with some examples of the present disclosure.

FIG. 17 is a block diagram of a particular illustrative example of a device that is operable to perform environment based user model creation and user verification, in accordance with some examples of the present disclosure.

### V. DETAILED DESCRIPTION

The above-described problems associated with performing user verification in different environments are solved by a device that performs environment based user model creation and user verification, as described herein. For example, although various use cases require user verification performance to be robust and accurate for different environments, e.g., in a car, outdoors, at home, in a restaurant, etc., in some environments the background environmental noise can be loud, which degrades user verification accuracy. In addition, an initial user enrollment is typically performed in a quiet environment to capture speech characteristics of the user. When performing user verification in different noisy environments, a mismatch between the enrollment environment and the verification environment can result in reduced user verification performance.

The environment based user model creation and user verification techniques described herein include performing a context detection operation in conjunction with performing user verification. Depending on the environment, such as an acoustic scene that is classified via an audio context detector, the user verification is performed using a user model specific for that environment, if available. A noise level can also be detected and used to determine an appropriate confidence threshold for the user verification.

According to some aspects, after an initial user enrollment, the user's utterances are extracted, and samples of the user's speech stored at the device during the ordinary usage of the device by the user. Context detection is performed for the collected user utterances to classify which environment each of the samples are collected from. Based on the classification results, the samples are labeled and grouped according to the detected environments. After a sufficient number of samples for a particular environment have been collected, a user model (also referred to as a “template”) specific to the particular environment is generated using the collected samples for that environment, and the resulting user model is available for use during user verification for utterances that are subsequently detected in that environment.

The disclosed techniques thus provides the technical advantage of improving user verification accuracy by using environment-specific user models to verify a particular user based on the particular environment in which the user's speech is captured, which helps to optimize user verification performance for each particular environment and minimize the domain and environment mismatch between enrollment and verification. Improving user verification accuracy enables reduction of errors in which an authorized user is not correctly verified, thus improving the user's experience, and also enables reduction of errors in which a non-authorized user is erroneously verified, thus improving device security. By automatically storing the user's speech samples in conjunction with their respective environments and automatically generating a new user model for a particular environment when a sufficient number of samples have been collected, continuous improvement in user verification accuracy is provided by adapting to new environments using samples obtained during normal use of the device and without requiring any specialized user interaction, such as additional enrollment operations, for generation of the new user models.

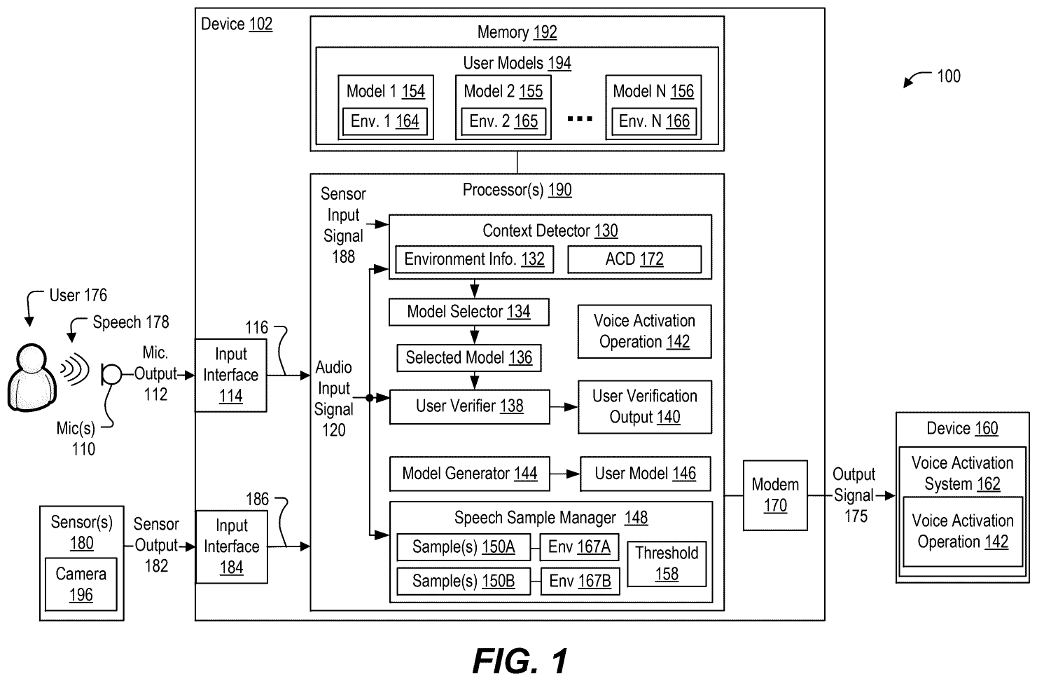

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple sets of samples are illustrated and associated with reference numbers 150A and 150B. When referring to a particular one of these sets of samples, such as samples 150A, the distinguishing letter “A” is used. However, when referring to any arbitrary one of these samples or to these samples as a group, the reference number 150 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 shows a block diagram of a system 100 that illustrates aspects of environment based user model creation and user verification. The system 100 includes a device 102 that is coupled to one or more microphones 110, one or more optional other sensors 180, and a second device 160. The device 102 is configured to perform various operations based on processing audio data, including speech 178 captured by the microphone 110, using a context detector 130 and a user verifier 138. As used herein, “speech” indicates a voice or utterance of a person (e.g., a user 176 of the device 102) as compared to sounds that do not originate from a user of the device 102, referred to herein as “noise” or “other audio activity.”

The device 102 includes a first input interface 114, one or more processors 190 coupled to a memory 192, and optionally includes a second input interface 184, a modem 170, or both. The first input interface 114 is coupled to the processor 190 and configured to be coupled to the microphone 110. The first input interface 114 is configured to receive a microphone output 112 from the microphone 110 and to provide the microphone output 112 to the processor 190 as an audio input 116, such as one or more audio data samples.

In an example that includes the second input interface 184 and the sensor 180, the second input interface 184 is coupled to the processor 190 and configured to be coupled to the sensor 180. The second input interface 184 is configured to receive a sensor output 182 from the sensor 180 and to provide the sensor output 182 to the processor 190. As illustrated, the sensor 180 includes one or more cameras 196, and the sensor output 182 includes a camera output, which is provided to the processor 190 as image data 186. Alternatively, or in addition, in some examples the sensor 180 includes one or more other sensors, such as one or more inertial sensors (e.g., accelerometers or gyroscopes), compasses, positioning sensors (e.g., a global positioning system (GPS) receiver), optical sensors, one or more other sensors to detect movement, position, or features in the vicinity of the device 102, or any combination thereof, to provide additional sensor data that can be included in the sensor output 182 and provided to the processor 190.

The memory 192 is configured to store multiple user models 194 indicative of speech characteristics of a user. As illustrated, the user models 194 include a first user model 154 corresponding to speech characteristics of a particular user in a first environment 164, a second user model 155 corresponding to speech characteristics of the same user in a second environment 165, and one or more other user models including an Nth user model 156 corresponding to speech characteristics of the same user in an Nth environment 166 (N is a positive integer). In the particular example of FIG. 1, each of the user models 194 corresponds to the speech characteristics of the user 176 in a respective environment 164-166. Although the user models 194 correspond to speech characteristics of the same user in different environments, in other examples the memory 192 stores multiple sets of user models 194 for various users of the device 102. Users may be added via an enrollment process that results in a first user model for a new user in an enrollment environment (e.g., a quiet room), and additional user models for existing users in different environments may be automatically generated and added to the user models 194 based on samples of the users' speech collected in the various environments, as described in more detail below.

The processor 190 includes the context detector 130 and the user verifier 138 and is configured to obtain an audio input signal 120 and process the audio input signal 120 at the context detector 130 and at the user verifier 138. In some examples, the processor 190 is configured to generate the audio input signal 120 via processing of the audio input 116. In an example, the processor 190 is configured to perform echo cancellation, noise suppression, or both, on the audio input 116 during generation of the audio input signal 120. Alternatively, or in addition, the processor 190 is configured to transform the audio input 116 (e.g., a Fourier transform) to a transform domain during generation of the audio input signal 120. In other examples, the audio input signal 120 may instead substantially match the audio input 116 (e.g., without applying echo cancellation, noise-suppression, transform, etc.).

The processor 190 is configured to perform a context detection operation at the context detector 130 to obtain environment information 132 associated with the audio input signal 120. In a particular example, the environment information 132 includes a classification of an environment of the device 102, such as at home, in a car, in a restaurant, in a subway, etc., as illustrative, non-limiting examples.

According to an aspect, the context detection operation includes audio environment detection, and the environment information 132 is based on a detected audio environment. To illustrate, the context detector 130 includes an audio context detector (ACD) 172 configured to perform a context detection operation based on the audio input signal 120. For example, audio context detection can be based on reverberation and absorption characteristics, detection of one or more types of ambient noise, detection of particular ambient noise sources, etc. In an example, the audio input signal 120 corresponds to an audio scene, and the environment information 132 is at least partially based on audio scene. To illustrate, based on the amount and type of noise detected in the audio data, as well as acoustic characteristics such as echoes and absorption, the audio scene can indicate that the device 102 is in a confined noisy space, a large enclosed space, a large outdoor space, a traveling vehicle, etc. In some examples, the context detection operation includes audio event detection, and the environment information 132 is further based on a detected audio event (e.g., a car horn, an alarm or siren, a baby crying, glass breaking, etc.). According to some aspects, the audio context detector 172 is further configured to determine, based on the audio input signal 120, a noise type, a noise level, or both, which may be included in the environment information 132 and used in conjunction with adjusting a confidence threshold at the user verifier 138, as described further below.

In some embodiments, the context detector 130 is configured to perform multi-modal context detection that is further based on one or more optional sensor input signals 188 corresponding to the sensor output 182 received from the sensor 180, to determine the environment information 132. In an example, the context detection operation performed by the context detector 130 further includes location detection (e.g., using positioning sensor data, dead reckoning based on inertial sensor data, etc.), and the environment information 132 is further based on the detected location. Alternatively, or in addition, in some examples the context detection operation is at least partially based on the image data 186 from the one or more cameras 196. To illustrate, the context detection operation can include image processing of one or more images or video included in the image data 186, and the environment information 132 is further based on the image processing.

The processor 190 includes a model selector 134 that is configured to select a user model, illustrated as a selected user model 136, from among the multiple user models 194 based on the environment information 132. In an illustrative example, the model selector 134 compares an environment classification indicated by the environment information 132 to one or more of the environments 164-166 associated with the user models 194 to identify a particular one of the user models 194 that corresponds to the detected environment. In some embodiments, if a match is not found, the model selector 134 selects a default user model (e.g., the first user model 154 generated during initial enrollment of the user 176), selects a user model that is associated with a most similar environment to the detected environment (e.g., based on a table of similarity metrics between various environments), selects a user model based on one or more selection criteria, or a combination thereof, to determine the selected user model 136.

The user verifier 138 is configured to obtain, based on the audio input signal 120 and the selected model 136, a user verification output 140 indicative of whether the audio input signal 120 corresponds to speech of the user 176. In some examples, the user verifier 138 is configured to determine the user verification output 140 based on a comparison of the selected model 136 and feature data that is based on the audio input signal 120. For example, the feature data can correspond to factors that may be unique to a particular person in the corresponding environment and associated with a shape of a person's vocal tract, such as pitch and linear prediction coding (LPC) coefficients. In accordance with some aspects, the feature data includes pitch data and formant data associated with speech. In some examples, the feature data includes additional or alternative feature types, such as where the user verifier 138 is configured to perform phrase-dependent classification, and in which the feature data further includes duration data and phrase-specific syllable cues. The user verifier 138 may compare the feature data from the audio input signal 120 to corresponding feature data from the selected user model 136 to determine a metric indicative of a similarity (or a distance) between the sets of feature data.

Alternatively, or in addition, in some examples the selected user model 136 includes an embedding corresponding to speech characteristics of the user 176, and the user verifier 138 includes a machine learning network that processes the audio input signal 120 and determines, based on the embedding, a metric indicating a similarity (or a distance) between the speech characteristics in the audio input signal 120 and the selected user model 136.

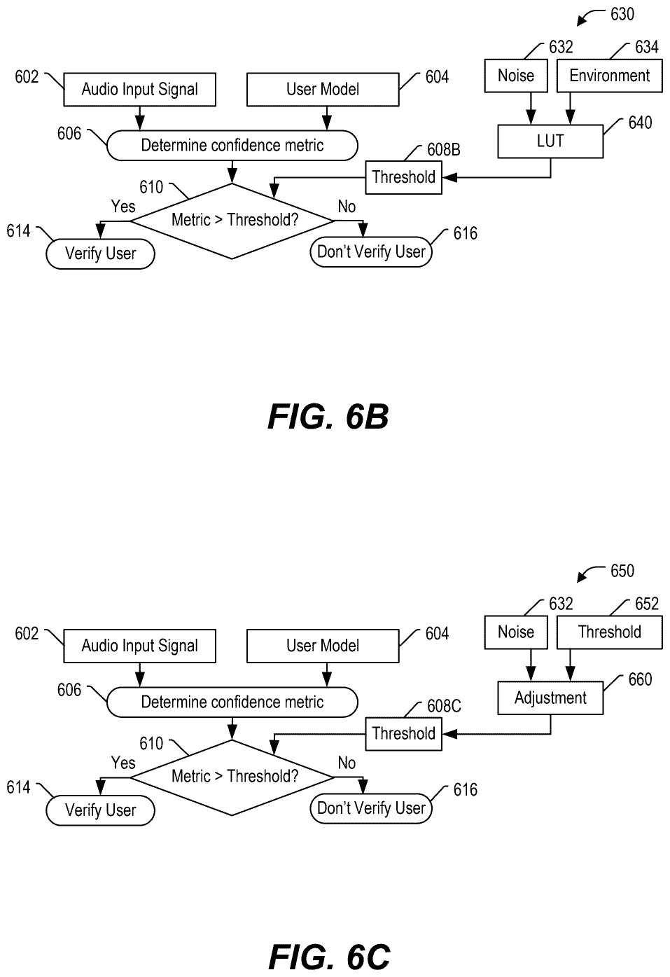

According to some aspects, the user verifier 138 is configured to compare the determined metric to a confidence threshold to determine whether the speech in the audio input signal 120 is from the same user that is associated with the selected user model 136, and the result is indicated the user verification output 140. In some examples, the user verifier 138 is configured to determine the confidence threshold based on a noise level associated with the audio input signal 120, and the user verification output 140 is at least partially based on the confidence threshold, such as described in further detail with reference to FIGS. 6B and 6C. Alternatively, the confidence threshold can be set to a default value that is independent of the noise level, such as described with reference to FIG. 6A.

In some implementations, the processor 190 is configured to selectively initiate a voice activation operation 142 based on the user verification output 140. For example, the user verification output 140 can be used to authenticate the user 176 as authorized to access the voice activation operation 142. In an illustrative example, the voice activation operation 142 includes speech recognition of a command in the audio input signal 120 and can include keyword or key phrase detection, natural language processing, one or more other operations, or any combination thereof.

In addition to performing context-based user verification by selecting a user model corresponding to a detected environment for user verification, the processor 190 is also configured to automatically generate new environment-specific user models to be added to the user models 194 as samples of the user's speech are received in various environments during regular operation of the device 102. To illustrate, the processor 190 includes a speech sample manager 148 that is configured to, based on the audio input signal 120 corresponding to speech of the user 176, store samples 150 of the speech of the user 176 as model training data associated with the environment information 132. As illustrated, the speech sample manager 148 manages first samples 150A and second samples 150B. The first samples 150A correspond to speech of the user 176 and are associated with a first particular environment 167A. The second samples 150B correspond to speech of the user 176 and are associated with a second particular environment 167B. Although the samples 150 are managed (e.g., indexed, sorted, etc.) by the speech sample manager 148, the actual samples 150 may be stored in the memory 192, in one or more other memory or storage devices of the device 102, in one or more remote libraries (e.g., at a remote sever or device, such as the second device 160), or a combination thereof.

The processor 190 is configured to, based on obtaining a threshold number 158 of samples 150 of the user's speech in a particular environment 167, automatically generate a user model 146, of the multiple user models 194, indicative of the user's speech characteristics for the particular environment 167. To illustrate, when the speech sample manager 148 determines that the number of first samples 150A of speech of the user 176 in first particular environment 167A meets or exceeds the threshold number 158, the processor 190 can provide the first samples 150A as model training data to a model generator 144, and the model generator 144 automatically generates the user model 146 using the model training data associated with the first particular environment 167A. According to an aspect, the model generator 144 is configured to automatically generate the user model 146 based on the speech sample manager 148 determining that the threshold number 158 of samples of the user's speech in a particular environment 167 have been obtained and without generation of a user prompt or receipt of a user command regarding generation of the user model 146.

After generating the user model 146, the user model 146 is added to the user models 194 and is available for selection by the model selector 134 when a later-received audio input signal 120 is detected, by the context detector 130, as being associated with the particular environment that is associated with the user model 146, e.g., the first particular environment 167A. In an illustrative example, the first particular environment 167A corresponds to “in car,” the user model 146 is generated based on the first samples 150A associated with the “in car” environment, and the user model 146 is stored as one of the user models 194, such as by adding the user model 146 to the user models 194 as the Nth user model 156, with the Nth environment 166 corresponding to an “in car” environment.

The modem 170 is coupled to the processor 190 and is configured to enable communication with the second device 160, such as via wireless transmission. In some examples, the modem 170 is configured to transmit model update information to the second device 160. To illustrate, in some embodiments the modem 170 sends an output signal 175 that includes the newly generated user model 146 to the second device 160, such as in an example in which the second device 160 includes a repository of user models. For example, the second device 160 may store user models that are available for use to verify the user 176 at one or more other devices.

In other examples, the modem 170 is configured to transmit an output signal 175 that includes the audio input signal 120 to the second device 160 in response to a determination that the audio input signal 120 corresponds to an authorized user based on the user verification output 140. For example, in an implementation in which the device 102 corresponds to a headset device that is wirelessly coupled to the second device 160 (e.g., a BLUETOOTH connection to a mobile phone or computer; BLUETOOTH® is a registered trademark of Bluetooth SIG, Inc., a Delaware Corporation), the device 102 may send the audio input signal 120 to the second device 160 to perform the voice activation operation 142 at a voice activation system 162 of the second device 160. In this example, the device 102 offloads more computationally expensive processing (e.g., the voice activation operation 142) to be performed using the greater processing resources and power resources of the second device 160. In other examples, the device 102 is configured to perform the voice activation operation 142, and the modem 170 is configured to transmit an output of the voice activation operation 142 (e.g., an instruction) to the second device 160 in response to the user verification output 140 indicating a user having access to the second device 160.

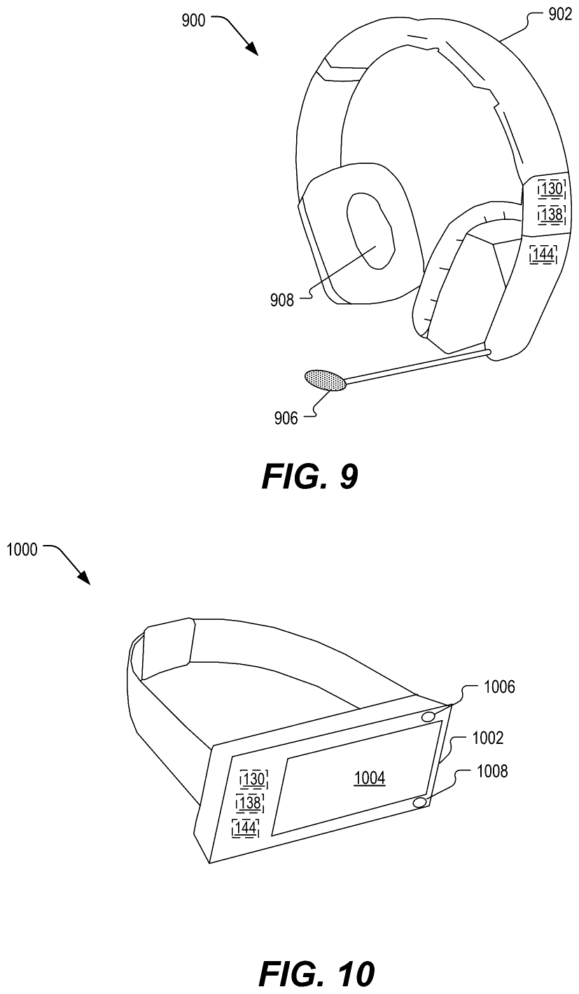

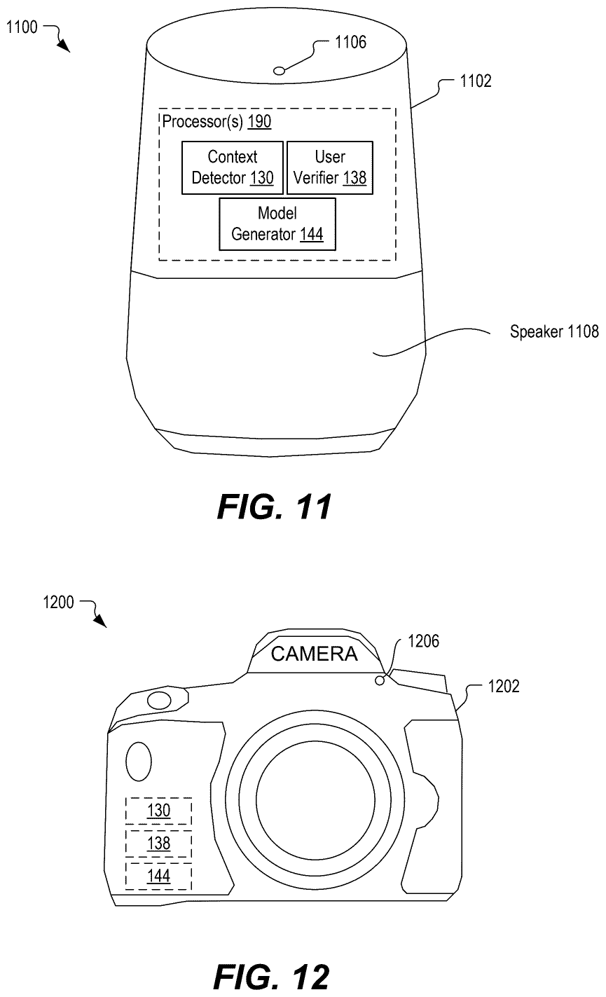

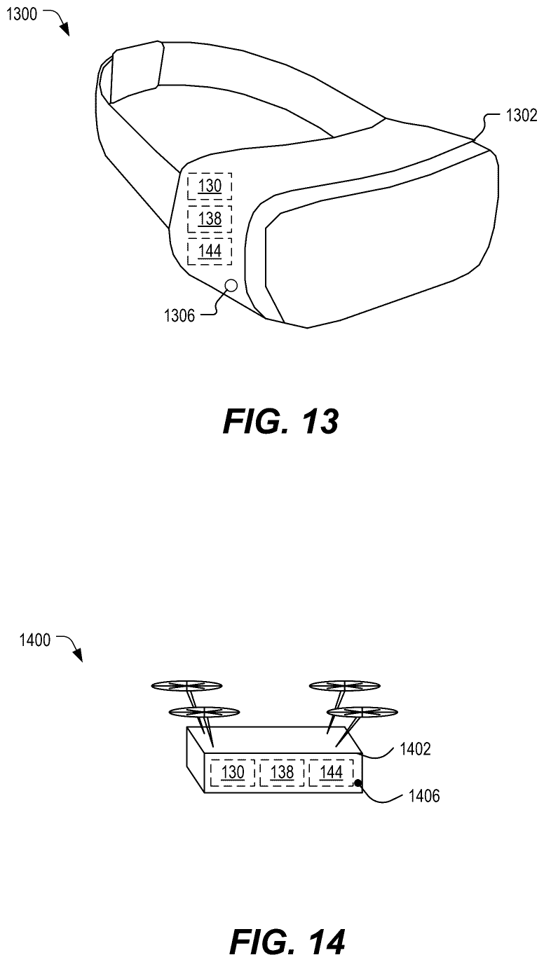

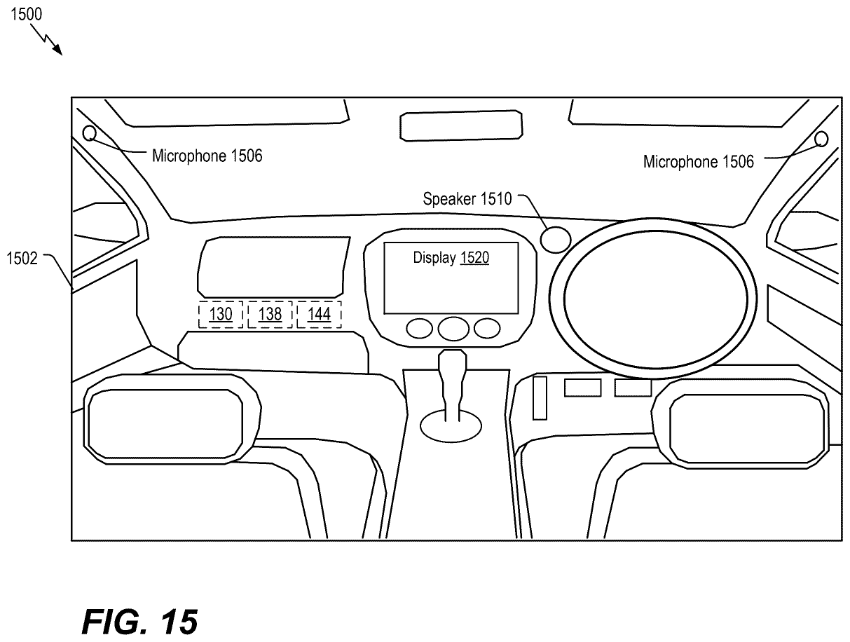

In some implementations, the device 102 corresponds to or is included in one of various types of devices. In an illustrative example, the processor 190 is integrated in a headset device, as described further with reference to FIG. 9. In other examples, the processor 190 is integrated in at least one of a mobile phone or a tablet computer device, as described with reference to FIG. 8, a wearable electronic device, as described with reference to FIG. 10, a voice-controlled speaker system, as described with reference to FIG. 11, a camera device, as described with reference to FIG. 12, or a virtual reality, mixed reality, or augmented reality headset, as described with reference to FIG. 13. In another illustrative example, the processor 190 is integrated into a vehicle, such as described further with reference to FIG. 14 and FIG. 15.

During operation, the microphone 110 is configured to capture speech 178 of a user 176. The audio input 116 may be processed at the processor 190, such as by performing echo cancellation, noise suppression, frequency domain transform, etc. The resulting audio input signal 120 is processed at the context detector 130 to determine the environment information 132, which is used by the model selector 134 to select the selected model 136. The selected model 136 is used by the user verifier 138 to generate the user verification output 140, which is interpreted by the processor 190 to determine, for example, whether the user 176 has authorization to perform one or more operations, such as the voice activation operation 142.

In some implementations, the sensor 180 is configured to capture one or more other aspects, such as an image of the environment around the device 102 that is captured via the camera 196. The image data 186 from the camera 196 is processed at the processor 190, such as by performing image filtering, frequency domain transform etc. The resulting processed image data may be included in the sensor input signal 188 and processed at the context detector 130 as part of determining the environment information 132, which is used by the model selector 134 to select the selected model 136.

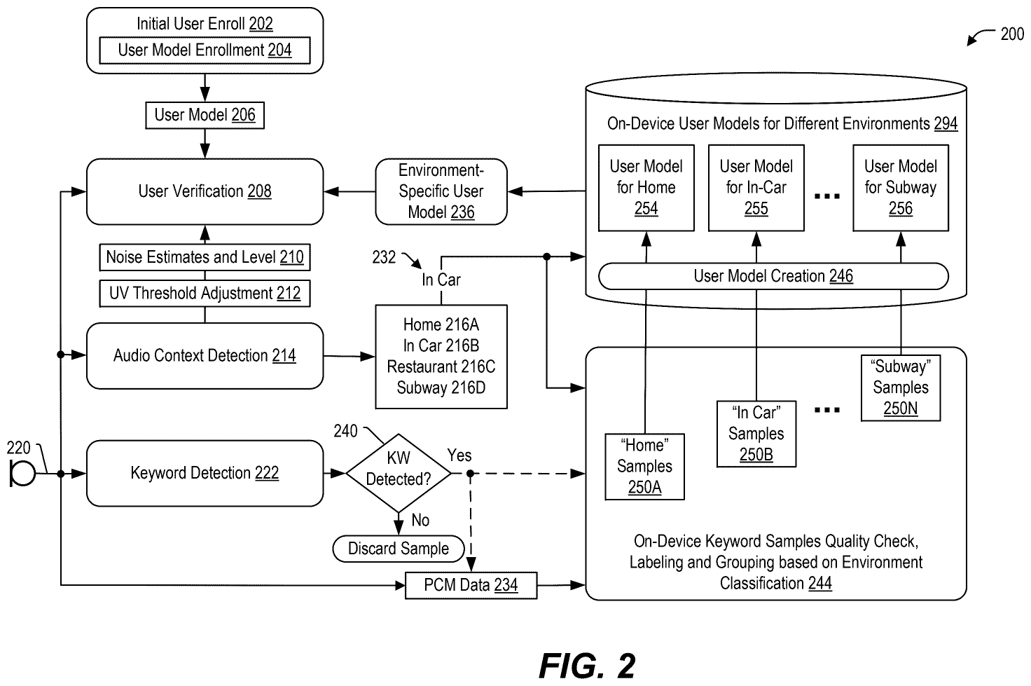

Upon obtaining and storing a threshold number of speech samples of the user 176 in a particular environment, the processor 190 generates a user model 146 for the particular environment. To illustrate, when the number of first samples 150A meets or exceeds the threshold number 158, the processor 190 uses the first samples 150A as model training data at the model generator 144 to generate a new or updated (e.g., re-trained) user model 146 for the first particular environment 167A. Additional details regarding operations that may be performed by the device 102 are described further with reference to FIGS. 2-6C.

The system 100 thus provides the technical advantage of improving user verification accuracy by using environment-specific user models 194 to verify a particular user based on the particular environment in which the user's speech is captured. Improving user verification accuracy enables reduction of errors in which an authorized user is not correctly verified, thus improving the user's experience, and also enables reduction of errors in which a non-authorized user is erroneously verified, thus improving device security. By automatically storing the user's speech samples in conjunction with their respective environments and automatically generating a new user model for a particular environment when the threshold number 158 of samples have been collected, the device 102 can provide continuous improvement in user verification accuracy by adapting to new environments using samples obtained during normal use of the device 102 and without requiring any specialized user interaction, such as additional enrollment operations, for generation of the new user models.

Although the microphone 110 and the sensor 180 are illustrated as being coupled to the device 102, in other implementations one or both of the microphone 110 or the sensor 180 may be integrated in the device 102. In some implementations, the sensor 180 is omitted, and authentication is performed based on audio data samples of the audio input 116 without using data samples (e.g., of the image data 186) from other sensors.

Although various systems are illustrated in the present disclosure as including a first device (e.g., the device 102) that performs environment based user verification and that is coupled to one or more additional devices (e.g., the second device 160) for purpose of explanation, it should be understood that, unless expressly indicated otherwise, such additional device(s) are optional and are not to be construed as required components or limitations. To illustrate, in accordance with some implementations, the device 102 uses the user verification output 140 to control operations, components, access, or other aspects of the functioning of the device 102 without being coupled to or in communication with the second device 160 or any other external device.

FIG. 2 illustrates an example of operations 200 to perform environment-based user verification at an electronic device, such as at the device 102 of FIG. 1. The operations 200 include an initial user enroll operation 202, such as a conventional user model enrollment 204 in which a user is prompted to provide input speech (e.g., via a microphone to generate an audio input signal 220) in a relatively quiet environment. The resulting input speech is processed to generate a user model 206 indicative of speech characteristics of the user.

After the initial user enroll operation 202, an audio input signal 220—e.g., speech that is received via a microphone input—can be processed for user verification using the user model 206. For example, for voice activation, a keyword detection operation 222 can be performed on the audio input signal 220 to determine whether a keyword is detected in the audio input signal 220. In addition, a user verification operation 208 can be performed on the audio input signal 220 to verify whether the audio input signal 220 includes speech that matches the speech characteristics of the user. For example, the user model 206 may be applied to the audio input signal 220 to generate a confidence metric indicating an amount of confidence that the speech is from the user, and the confidence metric can be compared to a confidence threshold to generate a user verification result. The results of the keyword detection operation 222 and the user verification operation 208 can be used to determine whether access is granted to one or more operations or systems of the electronic device. However, because the user model 206 is generated from user speech in a relatively quiet environment during the initial user enroll operation 202, the accuracy of the user verification operation 208 using the user model 206 can be reduced for user speech in different and/or noisy environments.

To improve user verification accuracy, the operations 200 implement a process by which samples of the user's speech are captured during normal operation in various environments and are used to generate multiple user models 294 that are indicative of speech characteristics of the user in different environments.

For example, when an audio input signal 220 is processed, an audio context detection operation 214 is performed to determine environment information, such as a particular detected environment 232 (e.g., “In Car”), that is associated with the audio input signal 220. To illustrate, the audio context detection operation 214 can include processing the audio input signal 220 to classify an environment from among multiple possible environments that can be detected by a classifier during the audio context detection operation 214, such as: “home” 216A, “in car” 216B, “restaurant” 216C, “subway” 216D, etc. Alternatively, in or addition, the audio context detection operation 214 can include noise level detection and/or audio event detection (e.g., detecting the presence of one or more of a car horn, siren, shouting, baby crying, glass breaking, etc.) using the audio input signal 220. In an illustrative example, the audio input signal 220 corresponds to the audio input signal 120 of FIG. 1 and the audio context detection operation 214 is performed by the context detector 130 (e.g., the audio context detector 172) of FIG. 1.

Samples 250 of the user's speech in different environments, illustrated as obtained from pulse-code modulation (PCM) data 234 of the audio input signal 220, are stored as model training data associated with the detected environment information. To illustrate, a set of samples 250 may be stored upon determining, at the keyword detection operation 222, that the samples 250 correspond to the user speaking a keyword (e.g., a word or phrase, such as “Hello Snapdragon”). For example, based on processing a sample 250 of the audio input signal 220 at the keyword detection operation 222, a determination 240 is made as to whether a keyword is detected in the sample. If no keyword is detected, the PCM data 234 corresponding to the sample is discarded.

If a keyword is detected, the sample 250 (e.g., the PCM data 234) corresponding to the keyword is processed at a quality check, labeling, and grouping operation 244 based on the detected environment 232 associated with the sample 250. In an illustrative example, the quality check, labeling, and grouping operation 244 includes labeling each sample 250 based on the detected environment 232 and grouping the samples 250 based on the environments associated with the samples 250. As illustrated, the samples 250 are grouped into N groups of samples, including “home” samples 250A, “in car” samples 250B, and “subway” samples 250N. In a particular example, the samples 250 correspond to the samples 150 of FIG. 1, and the quality check, labeling, and grouping operation 244 is performed by the speech sample manager 148 of FIG. 1.

After obtaining a threshold number of samples of the user's speech in a particular environment, those samples are used to automatically generate or update a user model, of the multiple user models 294, indicative of the user's speech characteristics for the particular environment. For example, a user model creation operation 246 is performed to generate or update a user model for the particular environment. As illustrated, the user models 294 include different models for various environments, illustrated as a user model for Home 254, a user model for In-Car 255, a user model for Subway 256, etc. According to an aspect, the user model creation operation 246 is performed by the model generator 144 of FIG. 1.

Once generated, the environment-specific user models 294 are available for use to improve the accuracy of the user verification operation 208. For example, in conjunction with obtaining a speech input at the audio input signal 220, the audio context detection operation 214 is performed to obtain environment information associated with the audio input signal 220. To illustrate, an audio context detection operation 214 can be performed using the audio input signal 220 to classify an environment (e.g., at home, in a car, in a restaurant, in a subway, etc.), and an environment-specific user model 236 is selected from among the multiple user models 294 based on the detected environment 232. The environment-specific user model 236 is used during the user verification operation 208 to obtain, based on the audio input signal 220 and the selected user model 236, a user verification output indicative of whether the audio input signal 220 corresponds to speech of the user. Using the environment-specific user model 236 provides enhanced accuracy in the particular environment as compared to using the initially generated user model 206.

In addition, the audio context detection operation 214 can provide noise data 210, such as noise estimates, a noise level, or both, for use during the user verification operation 208. In an example, a noise level associated with the audio input signal can be determined by the audio context detection operation 214, and the user verification operation 208 can determine or adjust a confidence threshold based on the noise level. Alternatively, or in addition, the audio context detection operation 214 can provide a user verification (UV) threshold level adjustment 212 that is based on the detected noise type and/or noise level to adjust the confidence threshold that is used during the user verification operation 208.

In a particular example, the user verification operation 208 can match the speech in the audio signal input 220 to the user with higher confidence in a low-noise environment but with lower confidence in a high-noise environment. The confidence threshold may therefore be raised in the presence of lower noise to reduce occurrences of errors in which another person's speech is accepted as the user's by the user verification operation 208, and lowered in the presence of higher noise to reduce occurrences of errors in which the user's speech is rejected by the user verification operation 208. Determining the user verification output at least partially based on the noise-adjusted confidence threshold can thus reduce errors and improve accuracy of the user verification operation 208.

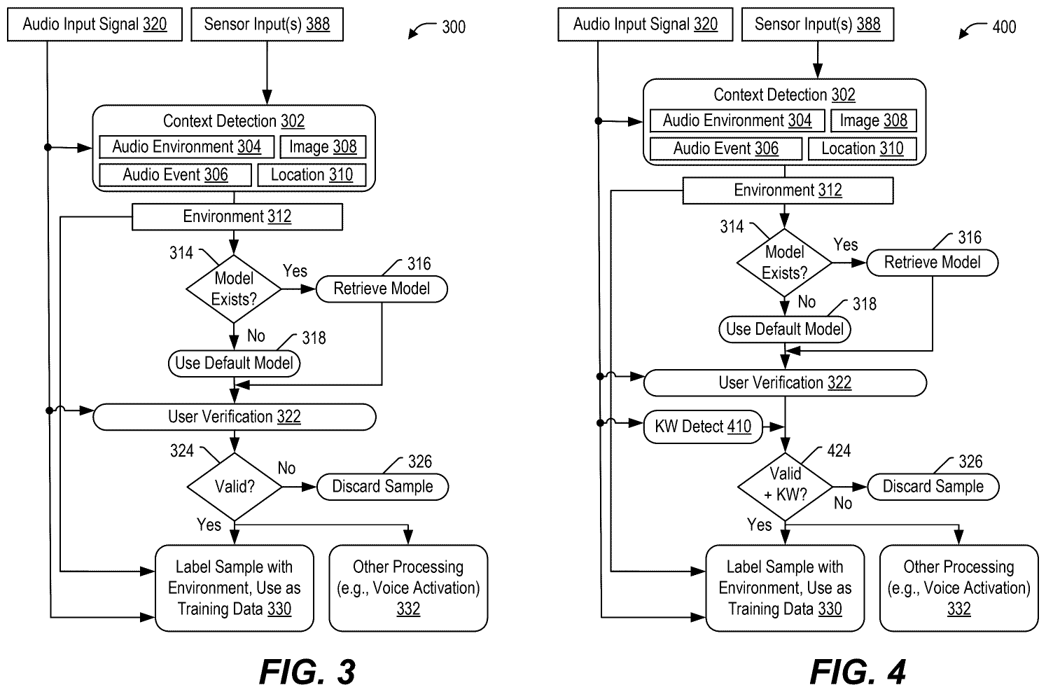

FIG. 3 illustrates an example of operations 300 to perform environment-based user verification at an electronic device, such as at the device 102 of FIG. 1. The operations 300 include performing a context detection operation 302 based on an audio input signal and optionally one or more sensor inputs 388 to generate environment information 312. According to a particular aspect, the context detection operation 302 is performed by the context detector 130 of FIG. 1, the audio input signal 320 corresponds to the audio input signal 120, the sensor input 388 corresponds to the sensor input signal 188, and the environment information 312 corresponds to the environment information 132.

The context detection operation 302 includes audio environment detection 304, and the environment information 312 is based on a detected audio environment, such as described with reference to the audio context detector 172 of FIG. 1. Optionally, the context detection operation 302 includes audio event detection 306, and the environment information 312 is based (e.g., at least partially based) on a detected audio event. For example, the audio event detection 306 can include processing the audio input signal 320 at one or more audio event classifiers to detect an audio event (e.g., a car horn, an alarm or siren, a baby crying, glass breaking, etc.).

Optionally, the context detection operation 302 includes image processing 308, and the environment information 312 is based (e.g., at least partially based) on the image processing 308. For example, the sensor input 388 may include image data, such as the image data 186 of FIG. 1 (e.g., image data, video data, or both), and the context detection operation 302 may include an image recognition model that is trained using a machine-learning technique to detect particular objects, motions, backgrounds, or other image or video information. In this example, output of the image recognition model may be evaluated via one or more heuristics to determine the environment information 312.

Optionally the context detection operation 302 includes location detection 310, and the environment information 312 is based (e.g., at least partially based) on a detected location. For example, the sensor input 388 may include location data from a location sensor, such as a global positioning sensor that provides global position data for the device 102. In this example, the location data may be evaluated via one or more heuristics to determine the environment information 312.

A determination 314 is made as to whether a user model exists that is associated with the environment information 312. For example, if the environment information 312 corresponds to “in car,” the model selector 134 of FIG. 1 may search the user models 194 to determine if any of the first environment 164, the second environment 165, etc. associated with the user models 194 also corresponds to “in car.” If one of the user models is determined to be associated with the environment information 312, the user model (e.g., the selected model 136 of FIG. 1) is retrieved for use with a user verification operation 322, at block 316. Otherwise, if none of the user models is determined to be associated with the environment information 312, a default model is used with the user verification operation 322, at block 318. In an example, the default model corresponds to a user model generated during an initial user enrollment, such as the user model 206 of FIG. 2.

The user verification operation 322 is performed on the audio input signal 320 using the environment-based user model, if available; otherwise, the user verification operation 322 is performed using the default model. According to an aspect, the user verification operation 322 is performed by the user verifier 138 of FIG. 1, corresponds to the user verification operation 208 of FIG. 2, or both.

A determination 324 is made as to whether the audio input signal 320 corresponds to speech of a valid user based on an output of the user verification operation 322. If the audio input signal 320 does not correspond to speech of a valid user (e.g., the user verification operation 322 detects that the speech characteristics in the audio input signal 320 do not sufficiently match the speech characteristics of the user model), the sample of the audio input signal 320 is discarded, at 326. Otherwise, at operation 330, the sample is labeled with the environment information 312 for later use as training data during generation of a new model (or updating of an existing model) associated with the environment information 312. In a particular example, the operation 330 corresponds to the quality check, labeling, and grouping operation 244 of FIG. 2, is performed by the speech sample manager 148 of FIG. 1, or both.

In addition to labeling the sample for later use as training data, the operations 300 also include performing other processing 332 when the audio input signal 320 corresponds to speech of a valid user. According to an aspect, the other processing 332 includes performing voice activation, such as the voice activation operation 142 associated with the audio input signal 120 of FIG. 1. In an illustrative example, performing the voice activation includes performing speech recognition of a command in the audio input signal 320.

FIG. 4 illustrates an example of operations 400 corresponding to performing environment-based user verification in conjunction with performing keyword detection at an electronic device, such as at the device 102 of FIG. 1. The operations 400 include the context detection operation 302, the determination 314, and the user verification operation 322 of FIG. 3.

The operations 400 also include a keyword detection operation 410 that is performed to determine whether one or more keywords is detected in the audio input signal 320. According to a particular aspect, the keyword detection operation 410 corresponds to the keyword detection operation 222 of FIG. 2. A determination 424 is made as to whether a first condition—the audio input signal 320 corresponds to speech of a valid user based on an output of the user verification operation 322—and a second condition-a keyword is detected in the audio input signal 320—are both satisfied. If either condition is not satisfied, the sample of the audio input signal 320 is discarded, at 326. Otherwise, the sample is labeled with the environment information 312 for later use as training data during generation of a new model (or updating of an existing model) associated with the environment information 312, at operation 330, and the other processing 332 is performed as described in FIG. 3. To illustrate, based on the output of the user verification operation 322 and the keyword detection operation 410, the operations 400 can selectively perform a voice activation operation associated with the audio input signal 320.

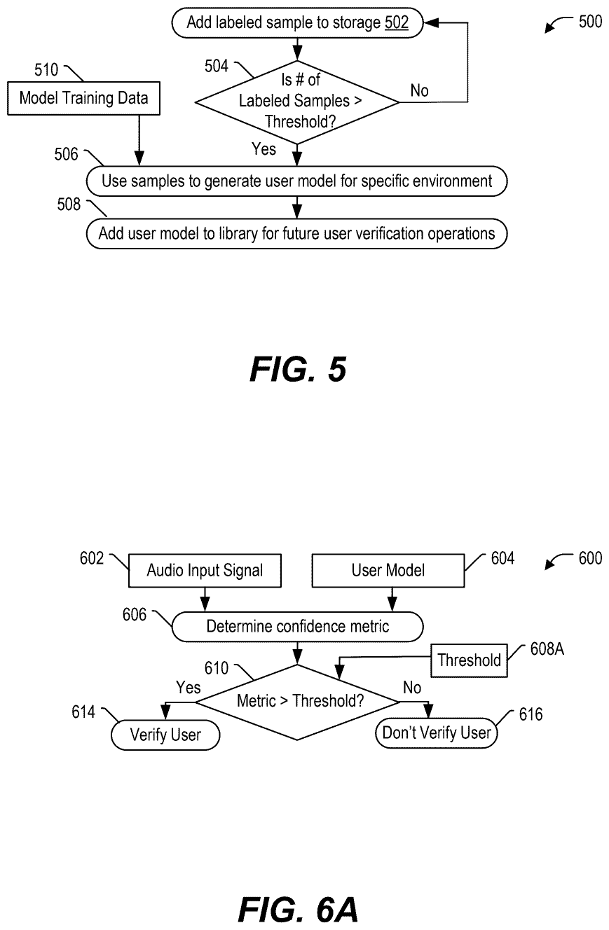

FIG. 5 illustrates an example of operations 500 associated with performing environment-based user verification at an electronic device, such as at the device 102 of FIG. 1. The operations 500 include adding a labeled sample of audio input data to a sample storage, at 502. According to an aspect, the labeled sample of audio data can correspond to a sample 150 of the audio input signal 120 that is labeled with a particular environment 167 of FIG. 1, a sample 250 of the audio input signal 220 that is labeled with a detected environment 232 of FIG. 2, or a sample of the audio input signal 320 that is labeled with the environment information 312 of FIG. 3 or FIG. 4, as illustrative, non-limiting examples.

A determination 504 is made as to whether the number of the labeled samples associated with the particular label exceeds a threshold. As an illustrative example, the sample of the audio input data can correspond to one of the first samples 150A of FIG. 1 that corresponds to speech of the user 176 and is associated with the first particular environment 167A (e.g., a “Home” label), and the number of the first samples 150A can be compared to the threshold number 158 by the speech sample manager 148.

If the number of labeled samples associated with the particular label exceeds the threshold, the labeled samples are used to generate a user model for the specific environment (e.g., “Home”) associated with the label, at operation 506. For example, model training data 510 can be used (e.g., by the model generator 144) to automatically generate the user model based on the labeled samples associated with the particular environment. In some examples, the labeled samples are stored as the model training data 510; alternatively, the model training data 510 can be generated based on the stored labeled samples. In some embodiments, generating the user model corresponds to updating an existing user model or creating a new user model for the specific environment. Updating an existing user model can include performing additional training of the existing user model using the labeled samples for the specific environment to improve accuracy of the existing user model in the specific environment. Creating a new user model can include training a new model using only the labeled samples for the specific environment, or alternatively using the labeled samples for the specific environment in addition to one or more other samples (e.g., samples from the initial user enroll operation 202 of FIG. 2).

The user model is added to a library of user models for future user verification operations, at operation 508. For example, the user model 146 is added to the user models 194 in the memory 192 to be available for selection by the model selector 134. As described above, the library of user models can include environment-specific user models that are stored locally (e.g., at the device 102), remotely (e.g., at the second device 160), or a combination thereof (e.g., one or more of the user models 194 may be stored locally, and one or more of the user models 194 may be stored remotely).

FIG. 6A illustrates an example of operations 600 associated with performing environment-based user verification at an electronic device, such as at the device 102 of FIG. 1. The operations 600 include determining a confidence metric, at operation 606, based on an audio input signal 602 (e.g., the audio input signal 120 of FIG. 1) and a user model 604 (e.g., the selected user model 136 of FIG. 1). For example, the confidence metric can correspond to a similarity (or difference) metric indicating an amount of similarity (or difference) between speech characteristics of speech in the audio input signal 602 and speech characteristics of a user associated with the user model 604.

The operations 600 include a determination 610 as to whether the confidence metric is greater than a confidence threshold 608A. When the confidence metric is greater than the confidence threshold 608A, the operations 600 include verifying the user, at operation 614; otherwise, when the confidence metric is not greater than the confidence threshold, the user is not verified, at operation 616. According to an aspect, the confidence threshold 608A corresponds to a default value that generally provides an acceptable error rate for false positives (e.g., a speaker is erroneously verified as the authorized user) and false negatives (e.g., the authorized user is erroneously rejected as an unverified speaker).

FIG. 6B illustrates another example of operations 630 associated with performing environment-based user verification at an electronic device, such as at the device 102 of FIG. 1. Similar to FIG. 6A, the operations 630 include determining the confidence metric, at operation 606, comparing the confidence metric to a confidence threshold 608, at determination 610, and verifying the user, at operation 614, or not verifying the user, at operation 616, based on the comparison. In contrast to FIG. 6A, the operations 630 use a confidence threshold 608B that is based on a noise level 632 associated with the audio input signal 602. According to an aspect, the noise level 632 is determined by an audio context detector, such as the audio context detector 172 of FIG. 1, based on the audio input signal 602. In an example, the noise level 632 is included in the noise data 210 that is generated by the audio context detection operation 214 of FIG. 2.

The confidence threshold 608B is obtained (e.g., retrieved) from a lookup table (LUT) 640 using a lookup operation that is based the noise level 632 and optionally also based on the particular environment 634 associated with capture of the audio input signal 602. According to an aspect, the LUT 640 is populated with empirically-determined values of the confidence threshold 608B for various combinations of noise levels 632 and various types of environments 634 to provide increased accuracy for various noise levels and environments as compared to using the default confidence threshold 608A of FIG. 6A.

FIG. 6C illustrates another example of operations 650 associated with performing environment-based user verification at an electronic device, such as at the device 102 of FIG. 1. Similar to FIG. 6B, the operations 630 include determining the confidence metric, at operation 606, comparing the confidence metric to a confidence threshold 608 that is based on a noise level 632 associated with the audio input signal 602, at determination 610, and verifying the user, at operation 614, or not verifying the user, at operation 616, based on the comparison. In contrast to FIG. 6B, the operations 650 use a confidence threshold 608C that is obtained by making an adjustment 660 to a confidence threshold 652 (e.g., a default threshold, such as the confidence threshold 608A of FIG. 6A) based on the noise level 632. According to an aspect, a value of the adjustment 660 is calculated for the particular noise level 632, and optionally may also be based on the environment 634, to provide increased accuracy for various noise levels.

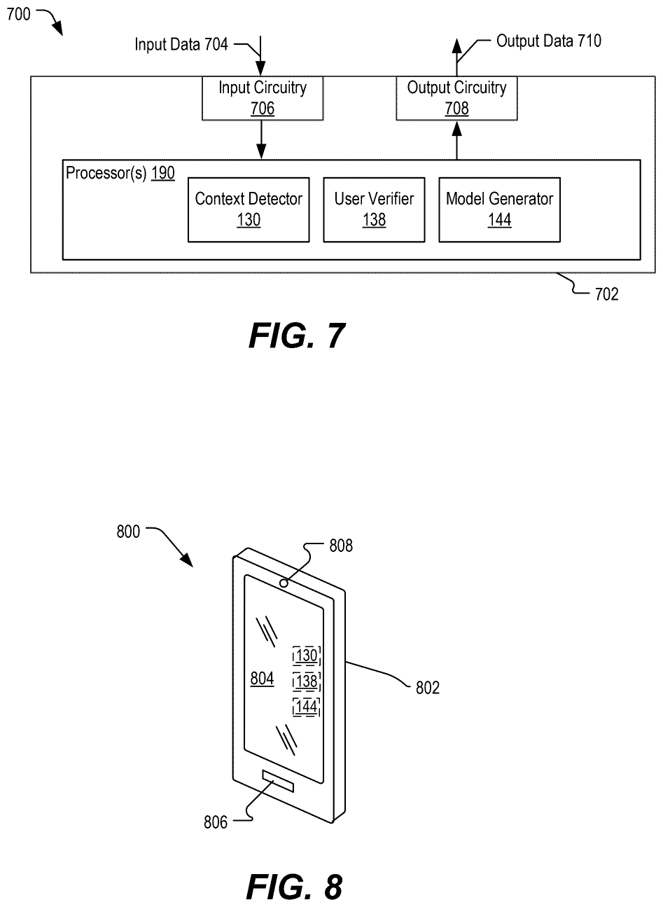

FIG. 7 depicts an implementation 700 of the device 102 as an integrated circuit 702 that includes the one or more processors 190. The integrated circuit 702 also includes input circuitry 706, such as one or more bus interfaces, to enable the integrated circuit 702 to receive signals representing input data 704 for processing. In an illustrative example, the input data 704 can correspond to or include the audio input 116, the image data 186, the audio input signal 120, the sensor input signal 118, data corresponding to one or more of the user models 194, or a combination thereof.

The integrated circuit 702 also includes output circuitry 708, such as a bus interface, to enable the integrated circuit 702 to output signals representing output data 710. For example, the output data 710 can correspond to or include the user verification output 140, the user model 146, the environment information 132, the output signal 175, or a combination thereof.

The integrated circuit 702 including the context detector 130, the user verifier 138, and the model generator 144 enables implementation of environment based user model creation and user verification as a component in a system, such as a mobile phone or tablet as depicted in FIG. 8, a headset as depicted in FIG. 9, a wearable electronic device as depicted in FIG. 10, a voice-controlled speaker system as depicted in FIG. 11, a camera as depicted in FIG. 12, a virtual reality, mixed reality, or augmented reality headset as depicted in FIG. 13, or a vehicle as depicted in FIG. 14 or FIG. 15.

FIG. 8 depicts an implementation 800 in which the device 102 includes a mobile device 802, such as a phone or tablet, as illustrative, non-limiting examples. The mobile device 802 includes one or more microphones 806, one or more speakers 808, and a display screen 804. Components of the processor 190, including the context detector 130, the user verifier 138, and the model generator 144, are integrated in the mobile device 802 and are illustrated using dashed lines to indicate internal components that are not generally visible to a user of the mobile device 802. In a particular example, the context detector 130 and the user verifier 138 are operable to obtain audio data representing sound captured by the microphone(s) 806, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced for the various environments.

FIG. 9 depicts an implementation 900 in which the device 102 includes a headset device 902. The headset device 902 includes one or more microphones 906 and one or more speakers 908. Components of the processor 190, including the context detector 130, the user verifier 138, and the model generator 144, are integrated in the headset device 902. In a particular example, the context detector 130, the user verifier 138, and the model generator 144 are operable to obtain audio data representing sound captured by the microphone(s) 906, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced for the various environments.

FIG. 10 depicts an implementation 1000 in which the device 102 includes a wearable electronic device 1002, illustrated as a “smart watch.” The wearable electronic device 1002 includes a display screen 1004, one or more microphones 1006, and one or more speakers 1008. Components of the processor 190, including the context detector 130, the user verifier 138, and the model generator 144, are integrated in the wearable electronic device 1002. In a particular example, the context detector 130, the user verifier 138, and the model generator 144 are operable to obtain audio data representing sound captured by the microphone(s) 1006, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced for the various environments. In some embodiments, the wearable electronic device 1002 is configured to generate a notification based on results of the environment based user verification. For example, the display screen 1004 can generate visual information based on determining whether a keyword or spoken command captured by the microphone(s) 1006 was spoken by the user. As another example, the wearable electronic device 1002 can include a haptic device that provides a haptic notification (e.g., vibrates) based on whether a keyword or spoken command captured by the microphone(s) 1006 was spoken by the user.

FIG. 11 is an implementation 1100 in which the device 102 includes a wireless speaker and voice activated device 1102. The wireless speaker and voice activated device 1102 can have wireless network connectivity and is configured to execute an assistant operation. The wireless speaker and voice activated device 1102 includes one or more microphones 1106 and one or more speakers 1108. Components of the processor 190, including the context detector 130, the user verifier 138, and the model generator 144, are integrated in the wireless speaker and voice activated device 1102. In a particular example, the context detector 130, the user verifier 138, and the model generator 144 are operable to obtain audio data representing sound captured by the microphone(s) 1106, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced for the various environments.

FIG. 12 depicts an implementation 1200 in which the device 102 includes a portable electronic device that corresponds to a camera device 1202. The camera device 1202 includes one or more microphones 1206. Components of the processor 190, including the context detector 130, the user verifier 138, and the model generator 144, are integrated in the camera device 1202. In a particular example, the context detector 130, the user verifier 138, and the model generator 144 are operable to obtain audio data representing sound captured by the microphone(s) 1206, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced during operation of the camera device 1202 in various environments.

FIG. 13 depicts an implementation 1300 in which the device 102 includes a portable electronic device that corresponds to a virtual reality, mixed reality, or augmented reality headset 1302. A visual interface device is positioned in front of the user's eyes to enable display of augmented reality, mixed reality, or virtual reality images or scenes to the user while the headset 1302 is worn. The headset 1302 also includes one or more microphones 1306. Components of the processor 190, including the context detector 130, the user verifier 138, and the model generator 144, are integrated in the headset 1302. In a particular example, the context detector 130, the user verifier 138, and the model generator 144 are operable to obtain audio data representing sound captured by the microphone(s) 1306, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced during operation of the headset 1302 in various environments.

FIG. 14 depicts an implementation 1400 in which the device 102 corresponds to, or is integrated within, a vehicle 1402, illustrated as a manned or unmanned aerial device (e.g., a package delivery drone). The vehicle 1402 includes one or more microphones 1406. Components of the processor 190, including the context detector 130, the user verifier 138, and the model generator 144, are integrated in the vehicle 1402. In a particular example, the context detector 130, the user verifier 138, and the model generator 144 are operable to obtain audio data representing sound captured by the microphone(s) 1406, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced during operation of the vehicle 1402 in various environments. For example, a spoken instruction for operation of the vehicle 1402 can be captured by the microphone(s) 1406 and processed to determine whether the spoken instruction is from an authorized user.

FIG. 15 depicts another implementation 1500 in which the device 102 corresponds to, or is integrated within, a vehicle 1502, illustrated as a car. The vehicle 1502 includes a display screen 1520, one or more microphones 1506, and one or more speakers 1508. Components of the processor 190, including the context detector 130, the user verifier 138, and the model generator 144, are integrated in the vehicle 1502. In a particular example, the context detector 130, the user verifier 138, and the model generator 144 are operable to obtain audio data representing sound captured by the microphone(s) 1506, the context detector 130 is operable to detect a particular environment and noise levels, and the user verifier 138 is operable to perform user verification using a environment specific user model based on the detected environment and using adjusted confidence thresholds based on the detected noise level. Samples of the audio data are labeled and grouped by environment, and the model generator 144 is operable to generate or update user models for particular environments based on the stored samples. Thus, user verification accuracy is enhanced during operation of the vehicle 1502 in various environments. For example, a spoken instruction for operation of the vehicle 1502 (e.g., a navigation instruction) can be captured by the microphone(s) 1506 and processed to determine whether the spoken instruction is from an authorized user of the vehicle 1502.

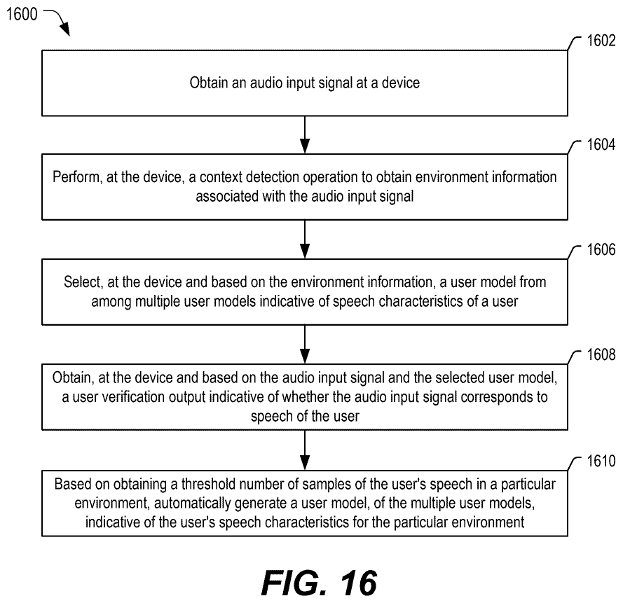

Referring to FIG. 16, a particular implementation of a method 1600 of environment based user model creation and user verification is shown. In a particular aspect, one or more operations of the method 1600 are performed by at least one of the context detector 130, the user verifier 138, the model generator 144, the processor 190, the device 102, the system 100 of FIG. 1, or a combination thereof.

In some embodiments, the method 1600 includes, at block 1602, obtaining an audio input signal at a device. For example, the processor 190 of the device 102 of FIG. 1 obtains the audio input signal 120, such as based on the audio input 116 corresponding to the speech 178 of the user 176.

The method 1600 also includes, at block 1604, performing, at the device, a context detection operation to obtain environment information associated with the audio input signal. For example, the context detector 130 of FIG. 1 performs a context detection operation, such as the audio context detection operation 214 of FIG. 2, to obtain the environment information 132 associated with the audio input signal 120.

The method 1600 also includes, at block 1606, selecting, at the device and based on the environment information, a user model from among multiple user models indicative of speech characteristics of a user. For example, the model selector 134 of FIG. 1 selects the selected user model 136 from among the user models 194 based on the environment information 132.

The method 1600 also includes, at block 1608, obtaining, at the device and based on the audio input signal and the selected user model, a user verification output indicative of whether the audio input signal corresponds to speech of the user. For example, the user verifier 138 performs a user verification operation, such as the user verification operation 208 of FIG. 2, based on the audio input signal 120 and the selected user model 136 to generate the user verification output 140.

The method 1600 also includes, at block 1610, based on obtaining a threshold number of samples of the user's speech in a particular environment, automatically generating a user model, of the multiple user models, indicative of the user's speech characteristics for the particular environment. For example, responsive to the speech sample manager 148 obtaining a number of the first samples 150A that exceeds the threshold number 158, the model generator 144 of FIG. 1 generates the user model 146 associated with the first particular environment 167A without generation of a user prompt or receipt of a user command regarding generation of the user model 146.

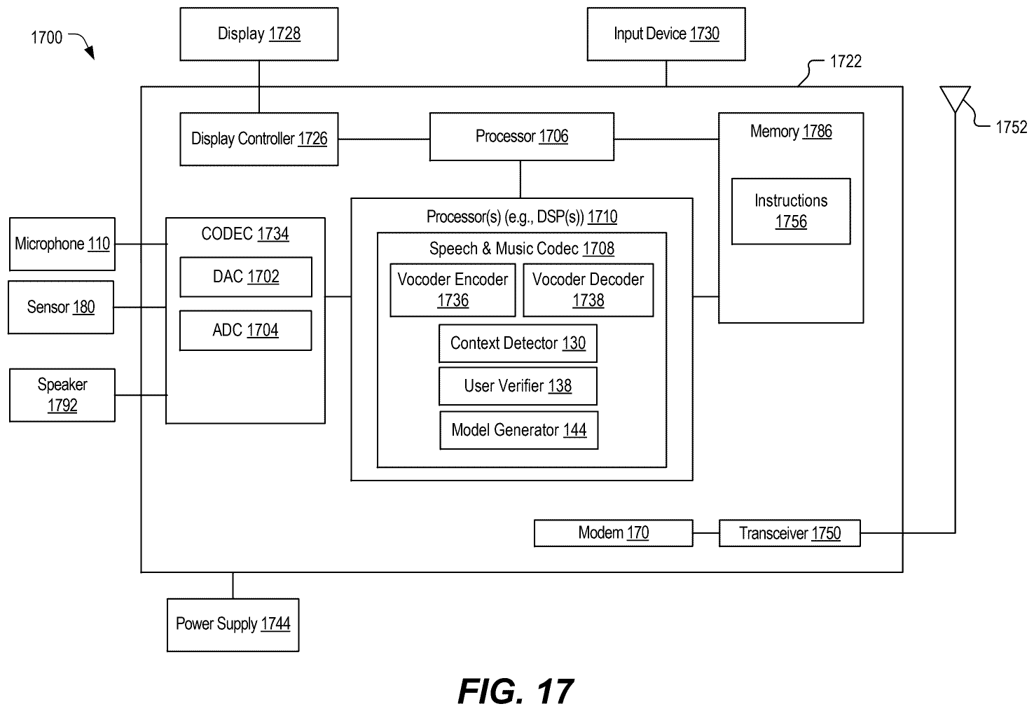

The method 1600 of FIG. 16 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1600 of FIG. 16 may be performed by a processor that executes instructions, such as described with reference to FIG. 17.

Referring to FIG. 17, a block diagram of a particular illustrative implementation of a device is depicted and generally designated 1700. In various implementations, the device 1700 may have more or fewer components than illustrated in FIG. 17. In an illustrative implementation, the device 1700 may correspond to the device 102. In an illustrative implementation, the device 1700 may perform one or more operations described with reference to FIGS. 1-16.

In a particular implementation, the device 1700 includes a processor 1706 (e.g., a central processing unit (CPU)). The device 1700 may include one or more additional processors 1710 (e.g., one or more DSPs). In a particular aspect, the processor 190 of FIG. 1 corresponds to the processor 1706, the processors 1710, or a combination thereof. The processors 1710 may include a speech and music coder-decoder (CODEC) 1708 that includes a voice coder (“vocoder”) encoder 1736, a vocoder decoder 1738, the context detector 130, the user verifier 138, and the model generator 144, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1700 may include a memory 1786 and a CODEC 1734. The memory 1786 may include instructions 1756, that are executable by the one or more additional processors 1710 (or the processor 1706) to implement the functionality described with reference to the context detector 130, the user verifier 138, and the model generator 144, or a combination thereof. The device 1700 may include the modem 170 coupled, via a transceiver 1750, to an antenna 1752.

The device 1700 may include a display 1728 coupled to a display controller 1726. One or more speakers 1792, the microphone(s) 110, and the sensor(s) 180 may be coupled to the CODEC 1734. The CODEC 1734 may include a digital-to-analog converter (DAC) 1702, an analog-to-digital converter (ADC) 1704, or both. In a particular implementation, the CODEC 1734 may receive analog signals from the microphone(s) 110, convert the analog signals to digital signals using the analog-to-digital converter 1704, and provide the digital signals to the speech and music codec 1708. The speech and music codec 1708 may process the digital signals, and the digital signals may further be processed by the context detector 130 and the user verifier 138 in conjunction with a user verification operation, and may also be stored for later processing by the model generator 144 to generate a new environment-specific user model. In a particular implementation, the speech and music codec 1708 may provide digital signals to the CODEC 1734. The CODEC 1734 may convert the digital signals to analog signals using the digital-to-analog converter 1702 and may provide the analog signals to the speaker 1792.

In a particular implementation, the device 1700 may be included in a system-in-package or system-on-chip device 1722. In a particular implementation, the memory 1786, the processor 1706, the processors 1710, the display controller 1726, the CODEC 1734, and the modem 170 are included in the system-in-package or system-on-chip device 1722. In a particular implementation, an input device 1730 and a power supply 1744 are coupled to the system-in-package or the system-on-chip device 1722. Moreover, in a particular implementation, as illustrated in FIG. 17, the display 1728, the input device 1730, the speaker(s) 1792, the microphone(s) 110, the sensor(s) 180, the antenna 1752, and the power supply 1744 are external to the system-in-package or the system-on-chip device 1722. In a particular implementation, each of the display 1728, the input device 1730, the speaker(s) 1792, the microphone(s) 110, the sensor(s) 180, the antenna 1752, and the power supply 1744 may be coupled to a component of the system-in-package or the system-on-chip device 1722, such as an interface or a controller.

The device 1700 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IOT) device, a virtual reality (VR) device, a base station, a mobile device, or any combination thereof.

In conjunction with the described implementations, an apparatus includes means for obtaining an audio input signal. For example, the means for obtaining an audio input signal can include the context detector 130, the user verifier 138, the speech sample manager 148, the processor 190, the input interface 114, the device 102, the integrated circuit 702, the processor 1706, the processor(s) 1710, the system-in-package or the system-on-chip device 1722, the device 1700, other circuitry configured to obtain an audio input signal or a combination thereof.

The apparatus also includes means for performing a context detection operation to obtain environment information associated with the audio input signal. For example, the means for performing a context detection operation to obtain environment information associated with the audio input signal can include the context detector 130, the processor 190, the device 102, the integrated circuit 702, the processor 1706, the processor(s) 1710, the system-in-package or the system-on-chip device 1722, the device 1700, other circuitry configured to perform a context detection operation to obtain environment information associated with the audio input signal, or a combination thereof.

The apparatus also includes means for selecting, based on the environment information, a user model from among multiple user models indicative of speech characteristics of a user. For example, the means for selecting, based on the environment information, a user model from among multiple user models indicative of speech characteristics of a user can include the model selector 134, the processor 190, the device 102, the integrated circuit 702, the processor 1706, the processor(s) 1710, the system-in-package or the system-on-chip device 1722, the device 1700, other circuitry configured to select, based on the environment information, a user model from among multiple user models indicative of speech characteristics of a user, or a combination thereof.

The apparatus also includes means for obtaining, based on the audio input signal and the selected user model, a user verification output indicative of whether the audio input signal corresponds to speech of the user. For example, the means for obtaining, based on the audio input signal and the selected user model, a user verification output indicative of whether the audio input signal corresponds to speech of the user can include the user verifier 138, the processor 190, the device 102, the integrated circuit 702, the processor 1706, the processor(s) 1710, the system-in-package or the system-on-chip device 1722, the device 1700, other circuitry configured to obtain, based on the audio input signal and the selected user model, a user verification output indicative of whether the audio input signal corresponds to speech of the user, or a combination thereof.

The apparatus also includes means for, based on obtaining a threshold number of samples of the user's speech in a particular environment, automatically generating a user model, of the multiple user models, indicative of the user's speech characteristics for the particular environment. For example, the means for automatically generating a user model, of the multiple user models, indicative of the user's speech characteristics for the particular environment can include the model generator 144, the speech sample manager 148, the processor 190, the device 102, the integrated circuit 702, the processor 1706, the processor(s) 1710, the system-in-package or the system-on-chip device 1722, the device 1700, other circuitry configured to, based on obtaining a threshold number of samples of the user's speech in a particular environment, automatically generating a user model, of the multiple user models, indicative of the user's speech characteristics for the particular environment, or a combination thereof.

In some implementations, a non-transitory computer-readable medium (e.g., a computer-readable storage device, such as the memory 1786) includes instructions (e.g., the instructions 1756) that, when executed by one or more processors (e.g., the one or more processors 1710 or the processor 1706), cause the one or more processors to obtain an audio input signal (e.g., the audio input signal 120); perform a context detection operation to obtain environment information (e.g., the environment information 132) associated with the audio input signal; select, based on the environment information, a user model (e.g., the selected user model 136) from among multiple user models (e.g., the user models 194) indicative of speech characteristics of a user; obtain, based on the audio input signal and the selected user model, a user verification output (e.g., the user verification output 140) indicative of whether the audio input signal corresponds to speech of the user; and based on obtaining a threshold number (e.g., the threshold number 158) of samples of the user's speech in a particular environment, automatically generate a user model (e.g., the user model 146), of the multiple user models, indicative of the user's speech characteristics for the particular environment.

Particular aspects of the disclosure are described below in sets of interrelated Examples:

According to Example 1, a device includes a memory configured to store multiple user models indicative of speech characteristics of a user; and one or more processors, coupled to the memory, wherein the one or more processors are configured to obtain an audio input signal; perform a context detection operation to obtain environment information associated with the audio input signal; select a user model from among the multiple user models based on the environment information; obtain, based on the audio input signal and the selected user model, a user verification output indicative of whether the audio input signal corresponds to speech of the user; and based on obtaining a threshold number of samples of the user's speech in a particular environment, automatically generate a user model, of the multiple user models, indicative of the user's speech characteristics for the particular environment.

Example 2 includes the device of Example 1, wherein the one or more processors are further configured to determine a confidence threshold based on a noise level associated with the audio input signal, and wherein the user verification output is at least partially based on the confidence threshold.

Example 3 includes the device of Example 1 or Example 2, wherein the one or more processors include an audio context detector configured to perform the context detection operation and determine the noise level based on the audio input signal.

Example 4 includes the device of any of Examples 1 to 3, wherein the one or more processors are further configured to, based on the user verification output and a keyword detection operation, selectively perform a voice activation operation associated with the audio input signal.

Example 5 includes the device of Example 4, wherein the voice activation operation includes speech recognition of a command in the audio input signal.

Example 6 includes the device of any of Examples 1 to 5, wherein the one or more processors are further configured to, based on the audio input signal corresponding to speech of the user, store samples of the speech of the user as model training data associated with the environment information.

Example 7 includes the device of Example 6, wherein the one or more processors are further configured to automatically generate the user model using the model training data.

Example 8 includes the device of Example 6 or Example 7, wherein the one or more processors are further configured to automatically generate the user model based on determining that the threshold number of samples of the user's speech in the particular environment have been obtained and without generation of a user prompt or receipt of a user command regarding generation of the user model.

Example 9 includes the device of any of Examples 1 to 8, wherein the context detection operation includes audio environment detection, and wherein the environment information is based on a detected audio environment.

Example 10 includes the device of Example 9, wherein the context detection operation includes audio event detection, and wherein the environment information is based on a detected audio event.

Example 11 includes the device of Example 9 or Example 10, wherein the context detection operation further includes location detection, and wherein the environment information is further based on a detected location.

Example 12 includes the device of any of Examples 9 to 11, wherein the context detection operation further includes image processing, and wherein the environment information is further based on the image processing.

Example 13 includes the device of any of Examples 1 to 12 and further includes one or more microphones coupled to the one or more processors, and wherein the audio input signal is based on audio input from the one or more microphones.

Example 14 includes the device of any of Examples 1 to 13 and further includes one or more cameras coupled to the one or more processors, and wherein the context detection operation is at least partially based on image data from the one or more cameras.

Example 15 includes the device of any of Examples 1 to 14 and further includes a modem coupled to the one or more processors, the modem configured to transmit model update information to a second device.

Example 16 includes the device of any of Examples 1 to 15, wherein the one or more processors are integrated in a headset device.

Example 17 includes the device of any of Examples 1 to 15, wherein the one or more processors are integrated in at least one of a mobile phone, a tablet computer device, a wearable electronic device, or a camera device.

Example 18 includes the device of any of Examples 1 to 15, wherein the one or more processors are integrated in a vehicle.

According to Example 19, a method includes obtaining an audio input signal at a device; performing, at the device, a context detection operation to obtain environment information associated with the audio input signal; selecting, at the device and based on the environment information, a user model from among multiple user models indicative of speech characteristics of a user; obtaining, at the device and based on the audio input signal and the selected user model, a user verification output indicative of whether the audio input signal corresponds to speech of the user; and based on obtaining a threshold number of samples of the user's speech in a particular environment, automatically generating a user model, of the multiple user models, indicative of the user's speech characteristics for the particular environment.

Example 20 includes the method of Example 19, further comprising determining a confidence threshold based on a noise level associated with the audio input signal, and wherein the user verification output is at least partially based on the confidence threshold.

Example 21 includes the method of Example 19 or Example 20, wherein an audio context detector of the device performs the context detection operation and determines the noise level based on the audio input signal.

Example 22 includes the method of any of Examples 19 to 21 and further includes, based on the user verification output and a keyword detection operation, selectively performing a voice activation operation associated with the audio input signal.

Example 23 includes the method of Example 22, wherein the voice activation operation includes speech recognition of a command in the audio input signal.

Example 24 includes the method of any of Examples 19 to 23 and further includes, based on the audio input signal corresponding to speech of the user, storing samples of the speech of the user as model training data associated with the environment information.

Example 25 includes the method of Example 24 and further includes automatically generating the user model using the model training data.

Example 26 includes the method of Example 24 or Example 25 and further includes automatically generating the user model based on determining that the threshold number of samples of the user's speech in the particular environment have been obtained and without generating a user prompt or receiving a user command regarding generation of the user model.

Example 27 includes the method of any of Examples 19 to 26, wherein the context detection operation includes audio environment detection, and wherein the environment information is based on a detected audio environment.

Example 28 includes the method of Example 27, wherein the context detection operation includes audio event detection, and wherein the environment information is based on a detected audio event.

Example 29 includes the method of Example 27 or Example 28, wherein the context detection operation further includes location detection, and wherein the environment information is further based on a detected location.

Example 30 includes the method of any of Examples 27 to 29, wherein the context detection operation further includes image processing, and wherein the environment information is further based on the image processing.

Example 31 includes the method of any of Examples 19 to 30, wherein the audio input signal is based on audio input from one or more microphones.

Example 32 includes the method of any of Examples 19 to 31, wherein the context detection operation is at least partially based on image data from one or more cameras.

Example 33 includes the method of any of Examples 19 to 32 and further includes transmitting model update information to a second device.

Example 34 includes the method of any of Examples 19 to 33, wherein the device corresponds to a headset device.

Example 35 includes the method of any of Examples 19 to 33, wherein the device corresponds to at least one of a mobile phone, a tablet computer device, a wearable electronic device, or a camera device.

Example 36 includes the method of any of Examples 19 to 33, wherein the device corresponds to a vehicle.

According to Example 37, a non-transitory computer-readable storage device storing instructions executable by one or more processors to cause the one or more processors to obtain an audio input signal; perform a context detection operation to obtain environment information associated with the audio input signal; select, based on the environment information, a user model from among multiple user models indicative of speech characteristics of a user; obtain, based on the audio input signal and the selected user model, a user verification output indicative of whether the audio input signal corresponds to speech of the user; and based on obtaining a threshold number of samples of the user's speech in a particular environment, automatically generate a user model, of the multiple user models, indicative of the user's speech characteristics for the particular environment.

Example 38 includes the non-transitory computer-readable storage device of Example 37, wherein the instructions are further executable to cause the one or more processors to determine a confidence threshold based on a noise level associated with the audio input signal, and wherein the user verification output is at least partially based on the confidence threshold.

Example 39 includes the non-transitory computer-readable storage device of Example 37 or Example 38, wherein the instructions are further executable to cause the one or more processors to perform the context detection operation and determine the noise level based on the audio input signal at an audio context detector.

Example 40 includes the non-transitory computer-readable storage device of any of Examples 37 to 39, wherein the instructions are further executable to cause the one or more processors to, based on the user verification output and a keyword detection operation, selectively perform a voice activation operation associated with the audio input signal.

Example 41 includes the non-transitory computer-readable storage device of Example 40, wherein the voice activation operation includes speech recognition of a command in the audio input signal.

Example 42 includes the non-transitory computer-readable storage device of any of Examples 37 to 41, wherein the instructions are further executable to cause the one or more processors to, based on the audio input signal corresponding to speech of the user, store samples of the speech of the user as model training data associated with the environment information.

Example 43 includes the non-transitory computer-readable storage device of Example 42, wherein the instructions are further executable to cause the one or more processors to automatically generate the user model using the model training data.

Example 44 includes the non-transitory computer-readable storage device of Example 42, wherein the instructions are further executable to cause the one or more processors to automatically generate the user model based on determining that the threshold number of samples of the user's speech in the particular environment have been obtained and without generating a user prompt or receiving a user command regarding generation of the user model.

Example 45 includes the non-transitory computer-readable storage device of any of Examples 37 to 44, wherein the context detection operation includes audio environment detection, and wherein the environment information is based on a detected audio environment.

Example 46 includes the non-transitory computer-readable storage device of Example 45, wherein the context detection operation includes audio event detection, and wherein the environment information is based on a detected audio event.

Example 47 includes the non-transitory computer-readable storage device of Example 45 or Example 46, wherein the context detection operation further includes location detection, and wherein the environment information is further based on a detected location.

Example 48 includes the non-transitory computer-readable storage device of any of Examples 45 to 47, wherein the context detection operation further includes image processing, and wherein the environment information is further based on the image processing.

Example 49 includes the non-transitory computer-readable storage device of any of Examples 37 to 48, wherein the audio input signal is based on audio input from one or more microphones.

Example 50 includes the non-transitory computer-readable storage device of any of Examples 37 to 49, wherein the context detection operation is at least partially based on image data from one or more cameras.

Example 51 includes the non-transitory computer-readable storage device of any of Examples 37 to 50, wherein the instructions are further executable to cause the one or more processors to transmit model update information to a second device.

Example 52 includes the non-transitory computer-readable storage device of any of Examples 37 to 51, integrated in a headset device.

Example 53 includes the non-transitory computer-readable storage device of any of Examples 37 to 51, integrated in at least one of a mobile phone, a tablet computer device, a wearable electronic device, or a camera device.

Example 54 includes the non-transitory computer-readable storage device of any of Examples 37 to 51, integrated in a vehicle.

According to Example 55, an apparatus includes means for obtaining an audio input signal; means for performing a context detection operation to obtain environment information associated with the audio input signal; means for selecting, based on the environment information, a user model from among multiple user models indicative of speech characteristics of a user; means for obtaining, based on the audio input signal and the selected user model, a user verification output indicative of whether the audio input signal corresponds to speech of the user; and means for, based on obtaining a threshold number of samples of the user's speech in a particular environment, automatically generating a user model, of the multiple user models, indicative of the user's speech characteristics for the particular environment.

Example 56 includes the apparatus of Example 55, and further includes means for determining a confidence threshold based on a noise level associated with the audio input signal, and wherein the user verification output is at least partially based on the confidence threshold.

Example 57 includes the apparatus of Example 55 or Example 56, wherein an audio context detector performs the context detection operation and determines the noise level based on the audio input signal.

Example 58 includes the apparatus of any of Examples 55 to 57 and further includes means for, based on the user verification output and a keyword detection operation, selectively performing a voice activation operation associated with the audio input signal.

Example 59 includes the apparatus of Example 58, wherein the voice activation operation includes speech recognition of a command in the audio input signal.

Example 60 includes the apparatus of any of Examples 55 to 59 and further includes means for, based on the audio input signal corresponding to speech of the user, storing samples of the speech of the user as model training data associated with the environment information.

Example 61 includes the apparatus of Example 60 and further includes means for automatically generating the user model using the model training data.

Example 62 includes the apparatus of Example 60 or Example 61 and further includes means for automatically generating the user model based on determining that the threshold number of samples of the user's speech in the particular environment have been obtained and without generating a user prompt or receiving a user command regarding generation of the user model.

Example 63 includes the apparatus of any of Examples 55 to 62, wherein the context detection operation includes audio environment detection, and wherein the environment information is based on a detected audio environment.

Example 64 includes the apparatus of Example 63, wherein the context detection operation includes audio event detection, and wherein the environment information is based on a detected audio event.

Example 65 includes the apparatus of Examples 63 or Example 64, wherein the context detection operation further includes location detection, and wherein the environment information is further based on a detected location.

Example 66 includes the apparatus of any of Examples 63 to 65, wherein the context detection operation further includes image processing, and wherein the environment information is further based on the image processing.

Example 67 includes the apparatus of any of Examples 55 to 66, wherein the audio input signal is based on audio input from one or more microphones.

Example 68 includes the apparatus of any of Examples 55 to 67, wherein the context detection operation is at least partially based on image data from one or more cameras.

Example 69 includes the apparatus of any of Examples 55 to 68 and further includes means for transmitting model update information to a second device.

Example 70 includes the apparatus of any of Examples 55 to 69, integrated in a headset device.

Example 71 includes the apparatus of any of Examples 55 to 69, integrated in at least one of a mobile phone, a tablet computer device, a wearable electronic device, or a camera device.

Example 72 includes the apparatus of any of Examples 55 to 69, integrated in a vehicle.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store multiple user models indicative of speech characteristics of a user; and
one or more processors, coupled to the memory, wherein the one or more processors are configured to:
obtain an audio input signal;
perform a context detection operation to obtain environment information associated with the audio input signal;
select a user model from among the multiple user models based on the environment information;
obtain, based on the audio input signal and the selected user model, a user verification output indicative of whether the audio input signal corresponds to speech of the user; and
based on obtaining a threshold number of samples of the user's speech in a particular environment, automatically generate a user model, of the multiple user models, indicative of the user's speech characteristics for the particular environment.

2. The device of claim 1, wherein the one or more processors are further configured to determine a confidence threshold based on a noise level associated with the audio input signal, and wherein the user verification output is at least partially based on the confidence threshold.

3. The device of claim 2, wherein the one or more processors include an audio context detector configured to perform the context detection operation and determine the noise level based on the audio input signal.

4. The device of claim 1, wherein the one or more processors are further configured to, based on the user verification output and a keyword detection operation, selectively perform a voice activation operation associated with the audio input signal.

5. The device of claim 4, wherein the voice activation operation includes speech recognition of a command in the audio input signal.

6. The device of claim 1, wherein the one or more processors are further configured to, based on the audio input signal corresponding to speech of the user, store samples of the speech of the user as model training data associated with the environment information.

7. The device of claim 6, wherein the one or more processors are further configured to automatically generate the user model using the model training data.

8. The device of claim 6, wherein the one or more processors are further configured to automatically generate the user model based on determining that the threshold number of samples of the user's speech in the particular environment have been obtained and without generation of a user prompt or receipt of a user command regarding generation of the user model.

9. The device of claim 1, wherein the context detection operation includes audio environment detection, and wherein the environment information is based on a detected audio environment.

10. The device of claim 9, wherein the context detection operation includes audio event detection, and wherein the environment information is based on a detected audio event.

11. The device of claim 9, wherein the context detection operation further includes location detection, and wherein the environment information is further based on a detected location.

12. The device of claim 9, wherein the context detection operation further includes image processing, and wherein the environment information is further based on the image processing.

13. The device of claim 1, further comprising one or more microphones coupled to the one or more processors, and wherein the audio input signal is based on audio input from the one or more microphones.

14. The device of claim 1, further comprising one or more cameras coupled to the one or more processors, and wherein the context detection operation is at least partially based on image data from the one or more cameras.

15. The device of claim 1, further comprising a modem coupled to the one or more processors, the modem configured to transmit model update information to a second device.

16. The device of claim 1, wherein the one or more processors are integrated in a headset device.

17. The device of claim 1, wherein the one or more processors are integrated in at least one of a mobile phone, a tablet computer device, a wearable electronic device, or a camera device.

18. The device of claim 1, wherein the one or more processors are integrated in a vehicle.

19. A method comprising:
obtaining an audio input signal at a device;
performing, at the device, a context detection operation to obtain environment information associated with the audio input signal;
selecting, at the device and based on the environment information, a user model from among multiple user models indicative of speech characteristics of a user;
obtaining, at the device and based on the audio input signal and the selected user model, a user verification output indicative of whether the audio input signal corresponds to speech of the user; and
based on obtaining a threshold number of samples of the user's speech in a particular environment, automatically generating a user model, of the multiple user models, indicative of the user's speech characteristics for the particular environment.

20. A non-transitory computer-readable storage device storing instructions executable by one or more processors to cause the one or more processors to:
obtain an audio input signal;
perform a context detection operation to obtain environment information associated with the audio input signal;
select, based on the environment information, a user model from among multiple user models indicative of speech characteristics of a user;
obtain, based on the audio input signal and the selected user model, a user verification output indicative of whether the audio input signal corresponds to speech of the user; and
based on obtaining a threshold number of samples of the user's speech in a particular environment, automatically generate a user model, of the multiple user models, indicative of the user's speech characteristics for the particular environment.
